(19) United States
(12) Patent Application Publication
(10) Pub. No.: US 2025/0384360 A1
(43) Pub. Date: Dec. 18, 2025

(54) METHOD AND SYSTEM FOR DIMENSION PREDICATION, PACKAGING OPTIMIZATION AND RATE SHIPPING TO ENHANCE E-COMMERCE LOGISTICS

(71) Applicant: Pitney Bowes Inc., Stamford, CT (US)

(72) Inventor: Abhay Raj Singh, Orange, CT (US)

(73) Assignee: Pitney Bowes Inc., Stamford, CT (US)

(21) Appl. No.: 19/240,735

(22) Filed: Jun. 17, 2025

Related U.S. Application Data
(60) Provisional application No. 63/661,224, filed on Jun. 18, 2024.
(60) Provisional application No. 63/797,718, filed on Apr. 30, 2025.

(51) Int. Cl. G06Q 10/04; G06Q 10/083

(52) U.S. Cl. CPC G06Q 10/04; G06Q 10/083

(57) ABSTRACT

A system and method for automatically gathering raw data relating to products offered for sale on e-Commerce websites and processing the raw data using generative artificial intelligence (AI) and statistical outlier detection to generate processed product data that is used to automatically determine the most efficient packaging configuration of the multiple purchased items into a single package for delivery to the user, the system further executing real-time carrier rate analysis to achieve optimal shipping based on carrier rates, speed and user preferences.

### CROSS-REFERENCE TO RELATED APPLICATIONS

This application claims the benefit of U.S. Application Ser. No. 63/661,224 filed Jun. 18, 2024 and claims the benefit of U.S. Application Ser. No. 63/797,718 filed Apr. 30, 2025, the entire contents of both which are incorporated by reference herein.

### BACKGROUND

### 1. Field of the Disclosure

The present disclosure relates to computer-implemented shipping optimization and, more particularly, to systems and methods that employ generative artificial intelligence (AI), statistical outlier detection, packaging optimization (cartonization), and real-time carrier rate analysis to improve fulfilment workflows in electronic commerce.

### 2. Description of Related Art

In the rapidly evolving e-Commerce landscape, efficient and accurate logistics are crucial for enhancing customer satisfaction and minimizing operational costs. Traditional methods of manual dimension measurement and standard packaging often lead to inefficiencies, increased expenses, and environmental concerns.

Considering the increasing speed of international trade and the growing expectations of consumers for rapid delivery, the shipping sector needs to move beyond its conventional methods. Traditionally centered on large-scale transportation, the industry is shifting its focus toward accuracy, dependability, and cost-efficiency to satisfy contemporary demands. The transition is primarily driven by digital transformation, which brings about an era of customized logistic solutions that specifically address the needs of individual consumers. Existing systems have mainly focused on systemic improvements or specific aspects of the supply chain, such as warehouse management or bulk transport efficiencies, rather than addressing the nuanced needs of e-Commerce retailers, who face diverse and rapidly changing consumer demands.

E-Commerce marketplaces (e.g. eBay, Etsy, Amazon and others) expose millions of user-generated product listings that vary widely in data quality, dimensional accuracy, and descriptive consistency. Conventional shipping pipelines rely on manual measurement or fixed cubic packaging assumptions, resulting in dimensional-weight miscalculations, penalties like Automated Package Verification (USPS: https://www.usps.com/business/verify-postage.htm, UPS: https://faq.usps.com/s/article/Automated-Package-Verification-Program), excess material usage, elevated transportation costs, and heightened carbon emissions. Existing rules-based solutions fail to scale across disparate catalogues and do not adapt to dynamic carrier pricing.

As such, current methods do not accurately account for a very wide range of package dimensions. However, e-Commerce sites often do provide some dimensional data relating to the various products that are provided for sale on the website. This dimensional data is often provided by the manufacturer; however, the data is often provided in many differing formats (e.g., inches, centimeters, product dimension as opposed to packaging dimension that encloses the product, and the like). This diverse data is difficult to automatically convert and even when converted, it can still be incorrect as the packaging size data is often not known or not differentiated from the product dimension data.

Still further, different websites provide differing data forms. While a human looking at a website can visually find where dimensional data is provided, it may be very difficult for a system to automatically scan the website for the data, which may be described in many differing forms. For example, the dimensions of a product may be described in any of the following ways: 8″×12″×24″, or 8 in×12 in×24 in, or 8 inches×12 inches×24 inches, or 8 in×1 ft×2 ft, and so on. All of these different descriptions can describe the same dimensional product, and while relatively easy for a human to decipher, may be very difficult for a system to automatically figure out. Additionally, the location of the dimensional data may be provided in table format with rows and columns where the row describes a product with a part number, and the columns provide the physical dimensions. These are just a few ways data can be presented in very diverse ways making it difficult for a system to automatically read from the tens of thousands of websites presenting data in vastly different ways. Even the location of the data on the page can provide challenges.

In addition, the current uniform approach is inadequate in meeting the specific and varied requirements of different customer segments, boosting the demand for more customized logistics solutions

Generative-Artificial Intelligence (Gen-AI) and predictive analytics have increasingly become useful in many industries. These technologies utilize large data sets to predict results and optimize intricate processes. These could be used for transforming shipping logistics. Gen-AI, specifically, provides innovative solutions and situations that significantly improve problem solving abilities in logistics, which were previously unachievable using traditional approaches. Predictive analytics improves this capability by allowing organizations to forecast market changes and adapt their strategy in advance.

Despite advancements, the sector still faces many challenges. One major issue is the high accuracy required in predicting dimensions and correctly packaging and labeling goods. Errors in these areas lead to higher operational costs, inefficient space utilization, and a more significant environmental impact due to the excessive and improper use of packing materials. In addition, the current uniform approach is inadequate in meeting the specific and varied requirements of different customer segments, boosting the demand for more customized logistics solutions

Accordingly, there is a need for a system that overcomes, alleviates, and/or mitigates one or more of the aforementioned and other deleterious effects of prior art dimensioning systems used for packaging multiple pre-packaged products into a single package for shipment to a customer.

### SUMMARY

What is needed then is a system and method that automatically gathers data from a plurality of websites related to dimensions of products sold on the website where the dimensional data is provided in a plurality of different formats from website to website.

It is desired to provide a system and method that automatically gathers dimensional data of products offered for sale on a plurality of websites in a plurality of formats and uses the gathered data to determine how a plurality of products can be packaged in a single shipping container in an efficient manner.

It is further desired to provide a system and method that automatically determines how to package a plurality of products in a single shipping container in a manner that uses the smallest shipping container needed to contain the selected products.

It is still further desired to provide a system and method that automatically derives a dimension for a prepackaged product using AI accessing dimensional data provided on a website relating to the dimensions of the product.

It is also desired to provide a system and method that provides an integrated solution that accurately predicts package dimensions and weights and dynamically interacts with e-Commerce platforms to optimize real-time packaging and shipping.

Accordingly, what is provided is an optimized AI-driven logistics framework that integrates predictive analytics to streamline e-Commerce operations. This method uses a Gen-AI-powered browser plugin that predicts and automatically inputs optimized dimensional data and directly suggests the most cost-effective shipping methods within the e-Commerce workflow.

The proposed system and methods comprise three key phases: automated dimensioning with weight prediction, optimized packaging strategy (cartonization), and intelligent rate shopping with dynamic recommendations. In the first phase, a custom-built browser plugin extracts product details from e-Commerce platforms, enabling generative AI models to predict accurate package dimensions and weights. The second phase employs advanced cartonization techniques to optimize packaging, minimize dimensional weight, and reduce shipping expenses. The final phase integrates an intelligent rate shopping algorithm that evaluates real-time carrier rates and applies business rules to recommend the most cost-effective or fastest shipping options based on operational constraints and user preferences.

The practical implementation of this framework for e-Commerce logistics demonstrates substantial efficiency gains, including reduced processing times for large-scale and complex fulfillment scenarios and a 95% packing efficiency, while lowering parcel spend by up to 18% compared with baseline operations, all while balancing multiple constraints such as weight distribution and volumetric utilization. The scalability and adaptability of the proposed solution make it suitable for diverse e-Commerce operations, ensuring seamless integration into high-volume supply chains. Designed to be robust yet adaptable, the system is adapted to solve issues relating to different products and shipping conditions, often overlooked in more generalized logistics systems.

In one configuration an optimized Gen-AI-based method uses generative and predictive analytics to improve shipping efficiency throughout the process, from predicting the dimensions of goods to the final delivery stage. The process includes creating a browser plugin that uses Gen-AI to reliably forecast package dimensions based on stock keeping unit (SKU) descriptions, weights, and quality data aiming to reduce automated package verification (APV) adjustments. It also provides real-time recommendations for the most cost-effective shipping rates. The plugin is adapted to seamlessly integrate current e-Commerce systems, enhancing all shipping procedures to ensure precision, swiftness, and cost-efficiency. This provides the ability to adjust to market fluctuations and cater to the specific requirements of each customer. Three advanced techniques are integrated to significantly improve e-Commerce logistics, from product listing to final delivery.
1) The first part of the method begins with integrating Gen-AI and predictive analytics into a custom-developed browser plugin. This integration enables the automated extraction and precise prediction of package dimensions and weights directly from e-Commerce platforms.
2) Next, using an optimized DL algorithm, the system implements a dynamic cartonization method that intelligently determines the most efficient packaging configuration. The system optimizes package structuring by analyzing the predicted product dimensions and weights to minimize dimensional weight and shipping costs.
3) Finally, building upon the optimized packaging data, the system includes a module that assesses real-time shipping rates from multiple carriers. This engine uses AI-driven decision algorithms and real-time data analytics to recommend the most economical or fastest shipping options for the user's specific preferences. This solution ensures that e-Commerce businesses can optimize their shipping strategies for cost efficiency and speed, enhancing customer satisfaction.

These contributions are key in simplifying e-Commerce operations, reducing operational costs, and improving the accuracy and efficiency of online shipping practices. Each phase addresses a specific aspect of the shipping and handling process and seamlessly integrates with the others to form a comprehensive solution that enhances seller and customer experiences in the e-Commerce domain.

In one configuration, a system is provided that ingests raw listing data directly from the e-Commerce marketplace (e.g., eBay, Etsy, Amazon and others) using web-browser plugins that automatically gathers information from the listing data. The web-browser plugin(s) comprises a software program that is installed on a user computer, which may comprise any type of computing device running a web browser application.

The software program is adapted to automatically perform the following functions:
1) Extract structured attributes.
2) Remove anomalous records.
3) Generate missing dimensional metadata.
4) Select an optimal package configuration.
5) Query multiple carriers to recommend a cost-or time-optimized shipping label.

In one configuration, a system and method includes: 1) data collection via a Data Gathering layer, 2) processing and cleaning of the data via a Pre-Processing and Cleaning layer, and 3) identifying anomalous data and correction via an Outlier Detection layer.

The data gathering step includes automatically pulling data from multiple websites, sellers and platforms relating to goods offered for sale. The data gathering step is subject to many challenges as the format and structure of data that describes the same product can greatly vary from platform to platform.

The pre-processing and cleaning step would typically include: 1) Text Normalization (strip HTML, remove special characters and emojis, lowercase text) with an encoding standard; 2) Feature Extraction (key attributes such as height, width, depth, weight) using regex & NLP patterns and Gen-AI LLM models to convert text to standardized units; and 3) Imputation by generating missing numeric attributes using a multiple imputation technique by iteratively inputting missing values. The missing values could comprise text fields where missing descriptions are replaced with category-level summaries. The missing values could comprise numeric fields in which median imputation or Multivariate Imputation by Chained Equations (MICE) may be used to generate the missing data.

The anomalous data detection step includes addressing any identified outlier data by means of univariate filters and multivariate filters.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The terms “user” or “users” mean a person or persons, respectively, who access a website in any manner, whether alone or in one or more groups, whether in the same or various places, and whether at the same time or at various different times.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “process” and “processing” as used herein each mean an action or a series of actions including, for example, but not limited to, the continuous or non-continuous, synchronous or asynchronous, routing of data, modification of data, formatting and/or conversion of data, tagging or annotation of data, measurement, comparison and/or review of data, and may or may not comprise a program.

In one configuration a system for automated dimensioning and optimized packaging of one or more purchased products via a computer accessing one or more e-Commerce websites via a network connection is provided, the system comprising: a software module adapted to access a database of information relating to products offered for sale on the one or more e-Commerce websites and executing on the computer. The software module includes: a Data Gathering layer adapted to extract structural attributes of a product to generate raw product data, a Pre-Processing and Cleaning layer adapted to normalize the raw product data, extract feature data, and generate missing dimensional data via a Generative Artificial Intelligence (Gen-AI) model to generate processed data, and an Outlier Detection layer adapted to utilize one or more filters to analyze the processed data to identify and remove anomalous data and generate corrected data, which is saved to the server storage. The system is provided such that the Gen-AI model is adapted to access the database of information and gather package dimensions for the one or more purchased products and the Gen-AI model is further adapted to generate a packing configuration for packaging of the one or more purchased products.

In another configuration a method for automated dimensioning and optimized packaging of one or more purchased products via a computer accessing one or more e-Commerce websites via a network connection, the computer having a software module executing thereon and accessing a database of information relating to products offered for sale on the one or more e-Commerce websites is provided, the method comprising the steps of: extracting structural attributes of a product to generate raw product data with a Data Gathering layer executing within the software module, and normalizing the raw product data, extracting feature data, and generating missing dimensional data via a Generative Artificial Intelligence (Gen-AI) model with a Pre-Processing and Cleaning layer executing within the software module. The method further comprises the steps of analyzing the processed data with one or more filters to identify and remove anomalous data and generate corrected data with an Outlier Detection layer executing within the software module, and saving the corrected data on the server storage Finally, the method comprises the steps of accessing the database of information and gather package dimensions for the one or more purchased products with the Gen-AI model, and generating a packing configuration for packaging of the one or more purchased products with the Gen-AI model.

The above-described and other features and advantages of the present disclosure will be appreciated and understood by those skilled in the art from the following detailed description, drawings, and appended claims.

### DESCRIPTION OF THE DRAWINGS

The patent or application file contains at least one drawing executed in color. Copies of this patent or patent application publication with color drawing(s) will be provided by the Office upon request and payment of the necessary fee

FIG. 1A is a block diagram illustrating the integrated AI-driven logistics optimization system according to one configuration.

FIG. 1B is a block diagram illustrating the structure of the system in greater detail according to the system of FIG. 1A.

FIG. 1C block diagram illustrating the structure of the system in greater detail according to the system of FIG. 1A.

FIG. 2 is a graph showing a distribution of product lengths according to a dataset utilized by the system of FIG. 1.

FIG. 3 is a log-scale correlation analysis between product length and weight according to a dataset utilized by the system of FIG. 1.

FIG. 4 illustrates an analysis of product volume across different categories according to a dataset utilized by the system of FIG. 1.

FIG. 5 is a graph that illustrates fluctuations in shipping costs across product categories according to a dataset utilized by the system of FIG. 1.

FIG. 6 is a graph that illustrates a distribution of estimated shipping costs according to a dataset utilized by the system of FIG. 1.

FIG. 7 is a flow diagram of the integrated AI-driven logistics optimization process according to system of FIG. 1.

FIG. 8 is a flow diagram illustrating the algorithmic processes of FIG. 7 in greater detail.

FIG. 9 is a screen shot illustrating plugin dimension prediction according to the system of FIG. 1.

FIG. 10 is a screen shot illustrating the cartonization process according to the system of FIG. 1.

FIG. 11 is a screen shot illustrating rate shopping and recommendations according to the system of FIG. 1.

FIG. 12 is an illustration of an error distribution in dimension and weight predictions according to the system of FIG. 1.

FIG. 13 is an illustration of density distribution of prediction errors across product categories according to the system of FIG. 1.

FIG. 14 is a graph illustrating the effect of AI-Based cartonization on space utilization according to the system of FIG. 1.

FIG. 15 is a graph illustrating comparison of processing speed before and after optimization according to the system of FIG. 1.

FIG. 16 is a graph illustrating cost savings achieved through AI-optimized rate shopping according to the system of FIG. 1.

FIG. 17 is a graph illustrating cost vs. speed tradeoff for rate shopping before and after optimization according to the system of FIG. 1.

### DETAILED DESCRIPTION

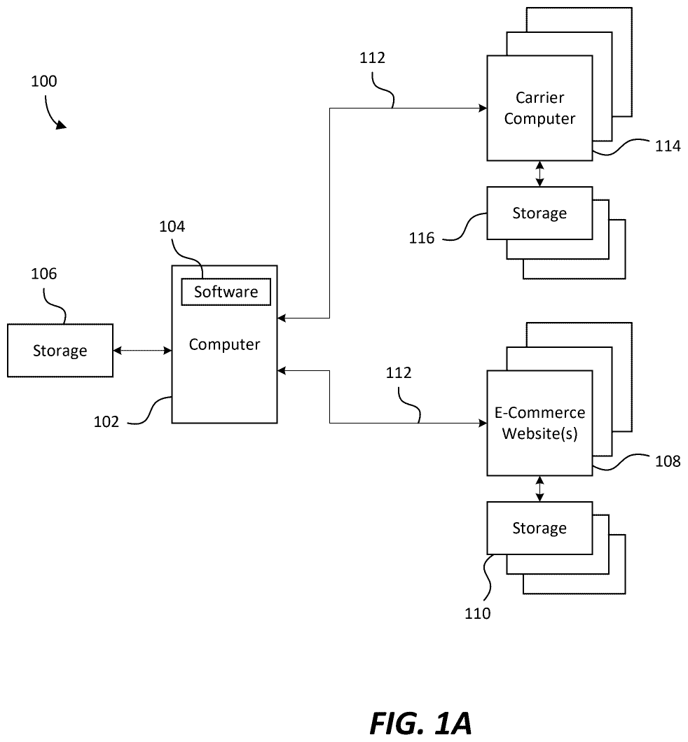

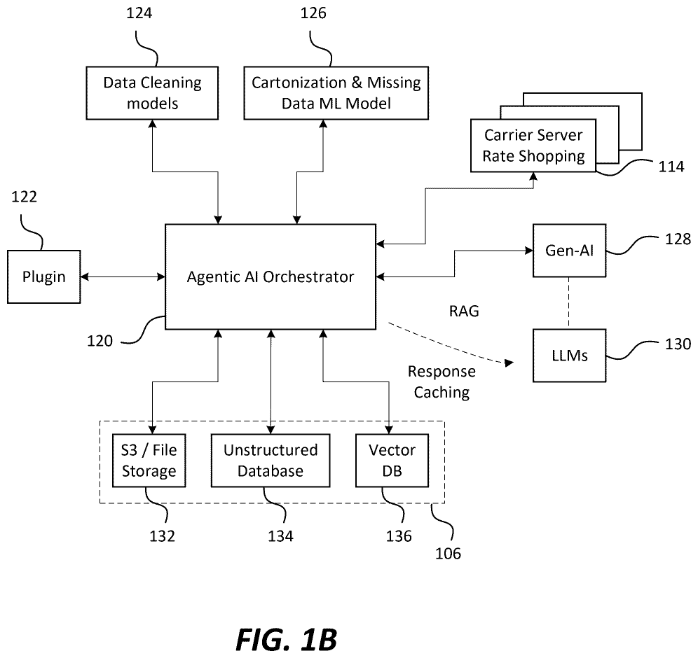

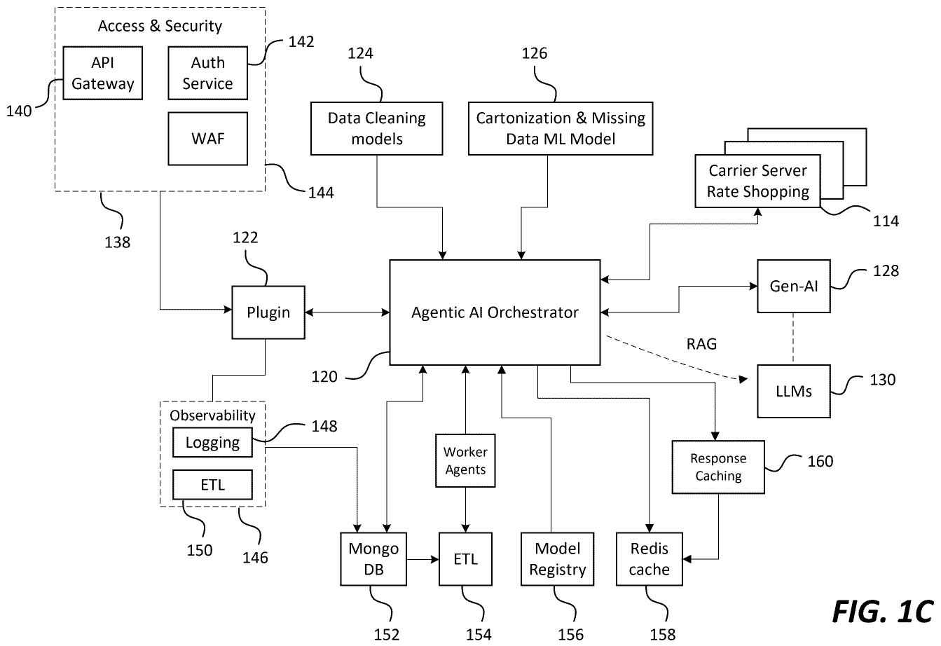

FIG. 1A is a block diagram of the system 100 for dimension prediction, packaging optimization and economized shipping. System 100 includes a computer 102 with a software module 104 executing thereon. Computer 102 is provided with a storage 106 that includes a database of information relating to products offered for sale by a plurality of e-Commerce website 108. Computer 102 has access to the plurality of e-Commerce websites 108 via a network connection 112. The plurality of e-Commerce websites 108 each have access to a storage 110 on which product information for the products offered for sale on the plurality of e-Commerce websites 108 is saved. Also depicted is a plurality of carrier computers 114, each of which has access to a storage 116.

The software module 104 is adapted to query the plurality of e-Commerce websites 108 to obtain product information that is saved on storage 106. Additionally, the software module 104 is adapted to query the plurality of carrier computers 114 to obtain shipping costs, which is used by the software module 104 for shipping items that have been purchased.

Referring now to FIG. 1B, the structure of the system is shown in greater detail, where a function of computer 102 is described as Agentic AI Orchestrator 120, which is the core of the system coordinating all services.

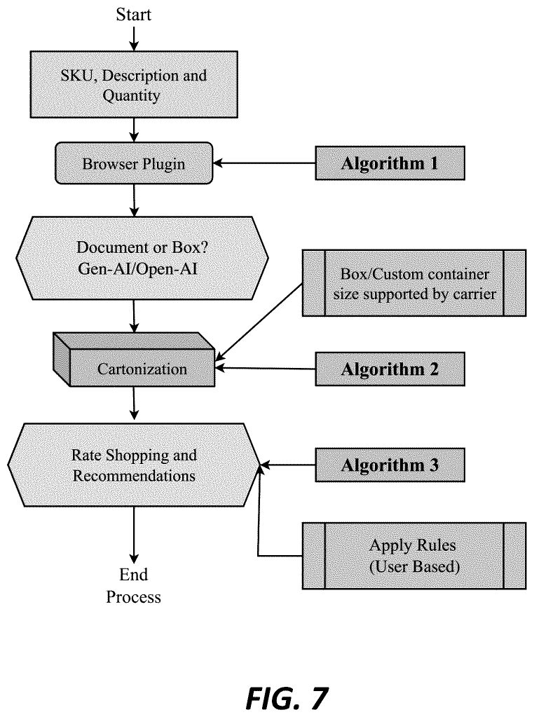

Plugin 122, Data Cleaning models 124, and Cartonization and Missing Data ML Model 126, which are functions of software 104 are all shown connected to Agentic AI Orchestrator 120. The plugin 122 signals where customers/eCommerce interacts to get and update the data for the various models. The functions of Data Cleaning models 124 and Cartonization and Missing Data ML Model 126 are described in connection with FIG. 7.

Gen-AI module 128 is connected to Agentic AI Orchestrator 120, while LLMs 130 is connected to Gen-AI module 128. A thin Gen-AI service handles prompt engineering, policy, and moderation, whereas LLMs defines a scalable LLM runtime (GPT-family, Claude, and the like). The dashed line therebetween is provided to emphasize that the Gen-AI feeds the final prompt/receives the completion, while the LLM tier can be swapped or multi-model.

Also shown in FIG. 1B is storage 106, which comprises S3/File Storage 132, Unstructured Database 134 and Vector Database 136. These could include, Simple Storage Service (S3)/File System, MongoDB, and Vector DB. Vector Database 136 feeds embeddings to the LLM tier (dashed “RAG” arrow) and stores cached responses for reuse.

Turning now to FIG. 1C a block diagram is provided according to FIGS. 1A & 1B illustrating some additional features/functionality in greater detail. Some functionality is identical to that discussed in connection with FIG. 1B and will not be redescribed here.

Access & Security 138 is depicted as an input to plugin 122. Access & Security 138 may include, API Gateway 140, Authentication Service 142 and WAF 144. Also depicted in FIG. 1B is Observability 146 that includes logging 148 and ETL 150 connected to or part of plugin 122. Observability 146 is also connected to Mongo Database 152, which in turn, is connected to ETL 154 and Agentic AI Orchestrator 120. Also shown is Model Registry 156, connected to Agentic AI Orchestrator 120, and Redis cache 158 also connected to Agentic AI Orchestrator 120. Agentic AI Orchestrator 120 is further connected to Response Caching 160, which is further connected to Redis cache 158.

Dataset Structure. To develop an AI-driven logistics optimization framework, a large-scale dataset was compiled from publicly available e-Commerce sources. The dataset provides structured product information, including textual metadata, categorical identifiers, and physical attributes, enabling a robust analysis of cartonization efficiency, dimensional weight estimation, and rate shopping optimization. With over 2.25 million entries, it serves as a comprehensive foundation for advancing AI-based logistics automation.

Each dataset entry corresponds to a unique SKU, comprising product-specific metadata such as titles, categorical identifiers, and structured descriptions. Additionally, it includes key numerical attributes, particularly product dimensions, which are crucial for determining packaging configurations and optimizing shipping costs. The integration of both structured and unstructured data allows AI models to enhance dimension prediction accuracy, facilitating automated packaging recommendations and dynamic shipping rate evaluations.

To ensure data consistency and usability, preprocessing steps were applied to address missing values, predominantly in descriptive fields, using imputation techniques, allowing models to leverage textual features effectively. Additionally, outlier detection was conducted to refine product dimensions to filter unrealistic values to maintain dataset reliability.

As cartonization efficiency is highly dependent on dimensional attributes, the dataset was curated to align with realistic packaging scenarios. Entries exhibiting extreme values inconsistent with standard e-Commerce logistics were removed, ensuring that the data remains representative of real-world shipping constraints. Text-based attributes were standardized to enhance AI-driven predictions, improving the accuracy of inferred dimensional and weight parameters.

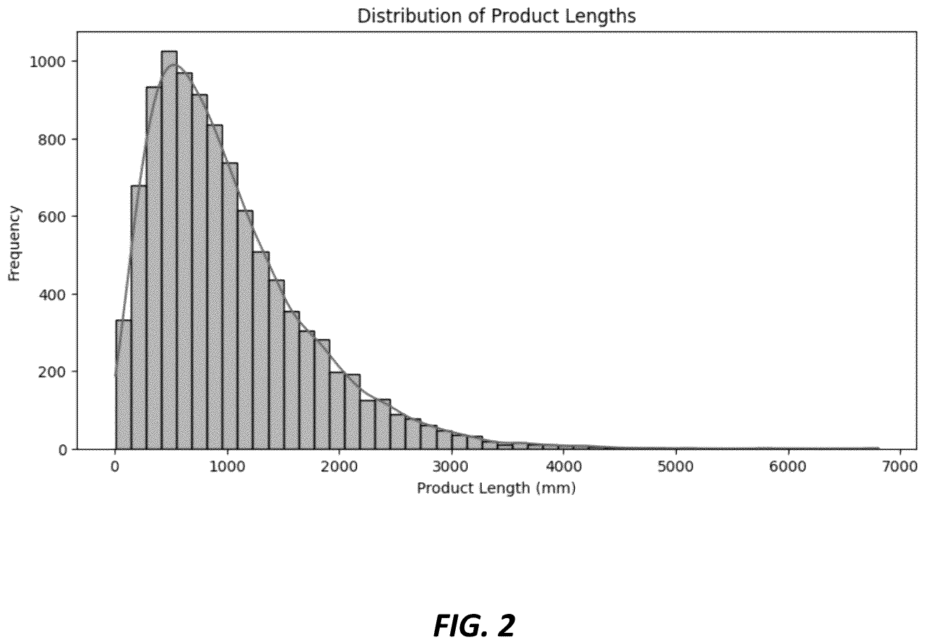

A statistical examination of product attributes revealed key distribution patterns essential for optimizing the proposed framework. The distribution of product lengths, illustrated in FIG. 2, demonstrates a positively skewed trend, indicating the predominance of small-to-medium-sized consumer goods. This insight is critical in refining cartonization models, as packaging optimization is highly influenced by the variability in product dimensions.

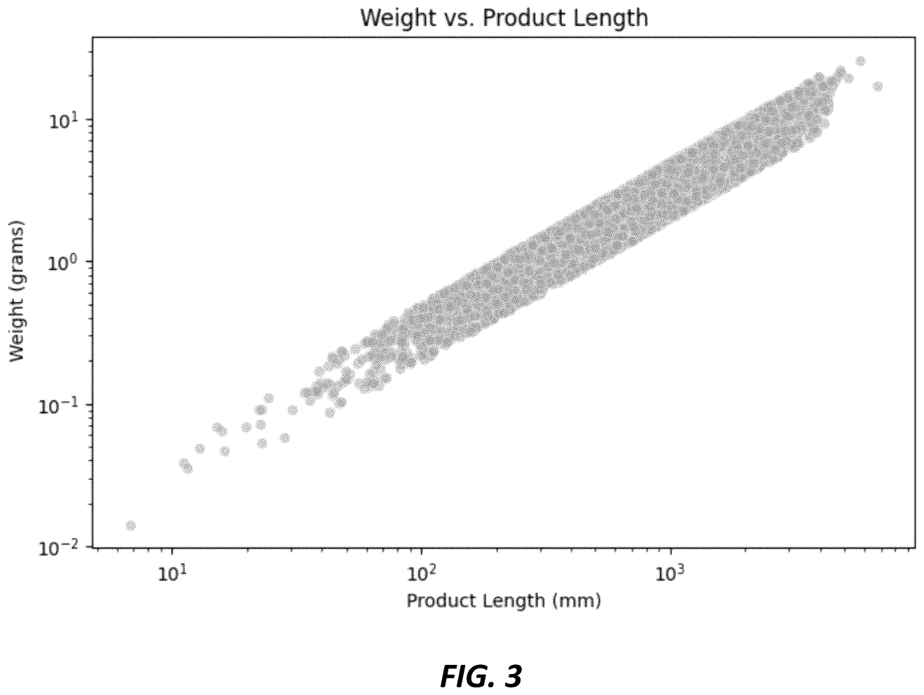

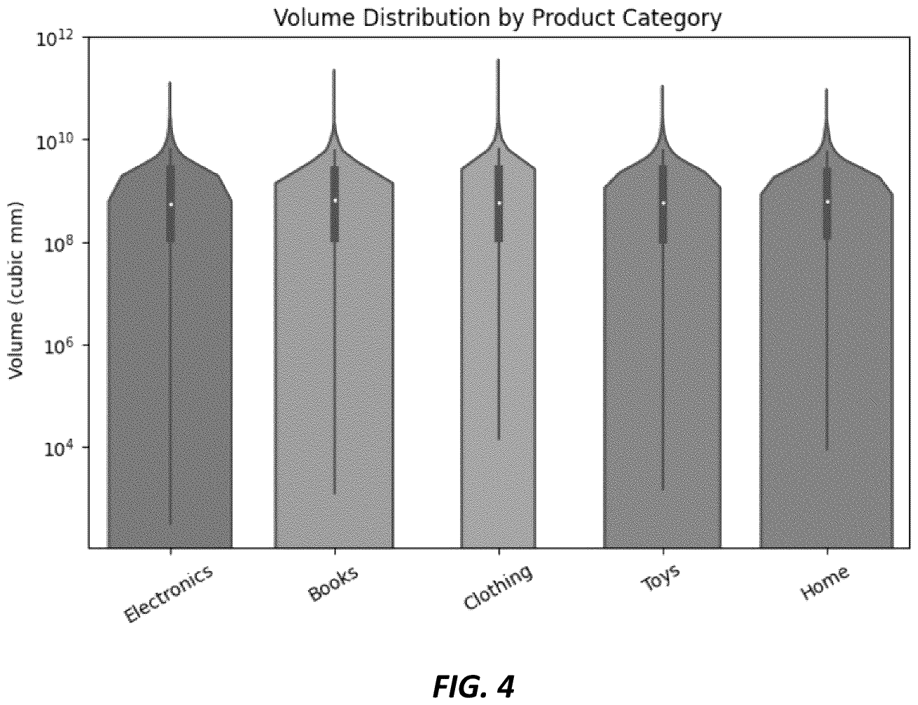

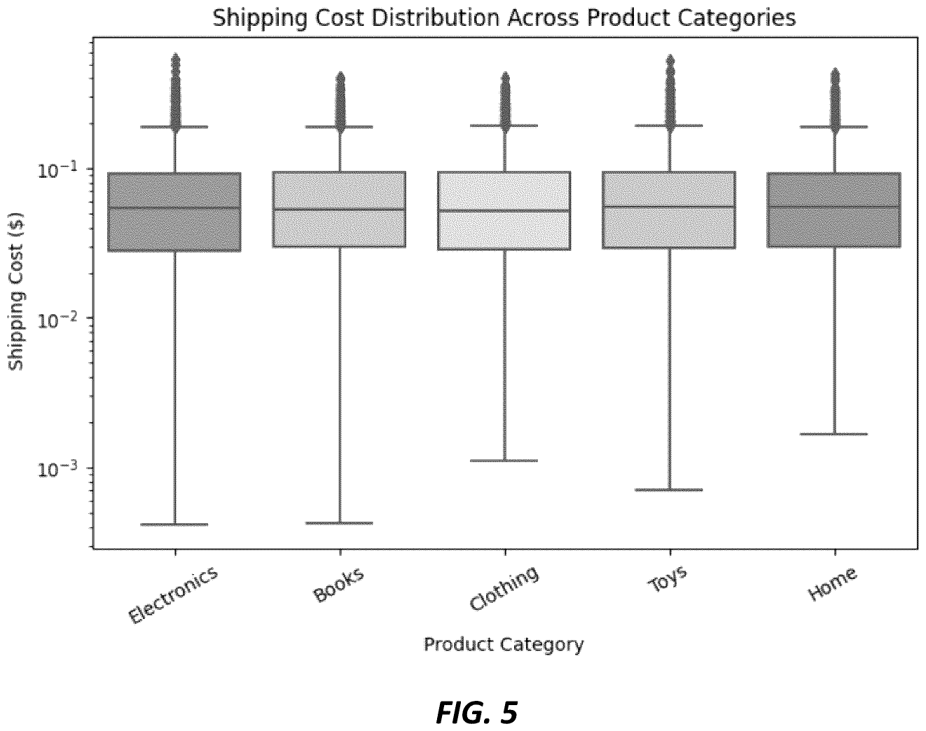

Further, a log-scale correlation analysis between product length and weight, as depicted in FIG. 3. This observation reinforces the feasibility of using AI-based predictions for missing dimensional attributes, reducing reliance on manually entered packaging specifications. An analysis of product volume across different categories, illustrated in FIG. 4, reveals significant variations in packaging requirements. This variability underscores the importance of adaptive cartonization strategies, ensuring efficient space utilization in shipping operations. The dataset also exhibits considerable fluctuations in shipping costs across product categories, as demonstrated in FIG. 5. This variability emphasizes the necessity of dynamic rate shopping algorithms, which can adjust to carrier-specific pricing models in real-time.

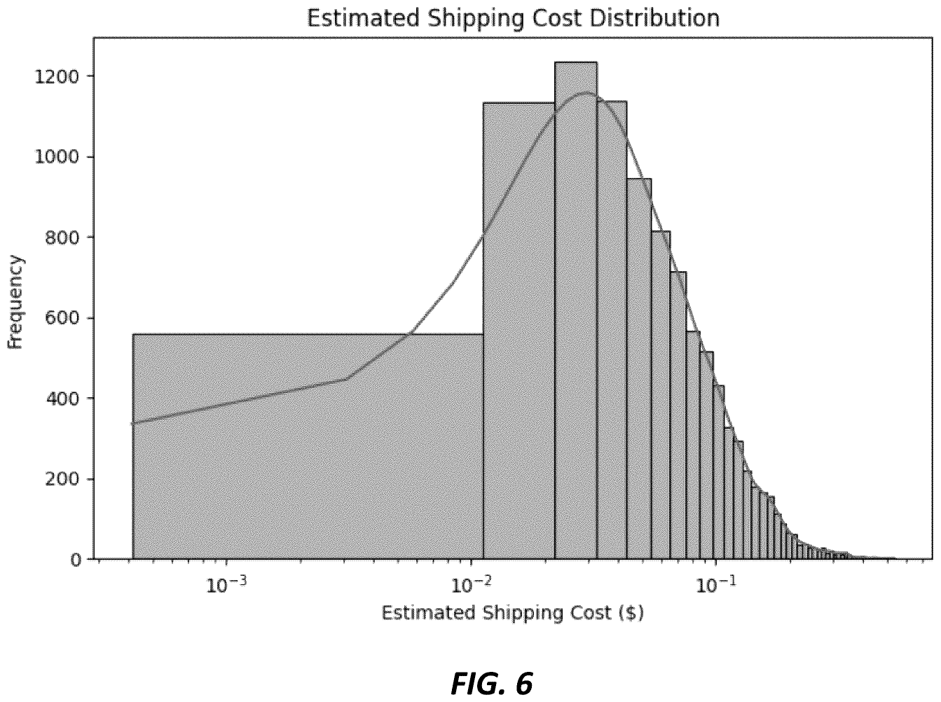

Additionally, FIG. 6 presents the distribution of estimated shipping costs, indicating a concentration of lower-cost shipments. This aligns with the dataset's composition, which is predominantly comprised of lightweight and compact products.

The dataset is curated to align with the objectives of the AI-driven logistics framework. Its extensive coverage of product attributes and packaging information allows for the seamless implementation of automated cartonization and rate shopping mechanisms. The structured numerical attributes provide a reliable basis for dimensional weight estimation, while the textual metadata enables AI-based feature extraction, improving accuracy in dimension prediction.

Methodology. Initially, the process starts with an extensive data collection phase, aggregating a diverse dataset from various e-Commerce platforms and logistics databases, before moving to the real-time data and plugin installation in websites. This data set includes SKU descriptions, weights, dimensions, and quality metrics. Data preprocessing techniques are then used such as cleaning, normalizing, and segmenting. These steps refine the data to be suitable for high-level AI modeling. The transformation of raw data into a normalized format ready for analysis is represented by the following equation:

$${D}^{′} = {f}_{preprocess} ( D ) \qquad Equation 1$$

Where D is the original dataset and D′ is the processed dataset, prepared through function f_{preprocess}.

Following data preprocessing, developing and training Gen-AI models for predicting optimal package dimensions is addressed. These models are engineered to minimize space utilization and adhere to shipping carrier constraints, thus reducing the need for APV adjustments. An optimized DL pipeline in utilized comprising training, validation, and testing stages to ensure the robustness and accuracy of the models. The model training can be formalized by the following equation:

$$M = train ( {D}^{′} , P ) \qquad Equation 2$$

Where M denotes the trained models and P represents the set of parameters defining the model architecture and training process, aimed at minimizing a defined loss function L.

A browser plugin is then provided that integrates seamlessly with leading e-Commerce platforms. This plugin is designed to automatically detect and input product weights and dimensions while providing real-time shipping rate comparisons to enhance operational efficiency and user experience. The integration of this plugin facilitates the immediate application of the Gen-AI models in a real-world environment, providing e-Commerce vendors with an automated tool for precision in logistics operations. The effectiveness of this plugin and the Gen-AI models is constantly refined through a feedback loop from user interactions and system-generated data, optimizing functionality. This continuous improvement cycle is encapsulated in the iterative equation:

$${P}_{new} = optimize ( P , F ) \qquad Equation 3$$

Where F represents feedback data used to refine the parameters P. These methodological steps culminate in deploying the Rate Shopping and Recommendations Algorithm, which utilizes the outputs of the Gen-AI models to evaluate and recommend the most cost-efficient or fastest shipping methods available as follows:

$$R = rate\_shop ( M , S ) \qquad Equation 4$$

Where S stands for shipping parameters and constraints and integrates real-time data from various carriers to provide tailored shipping options.

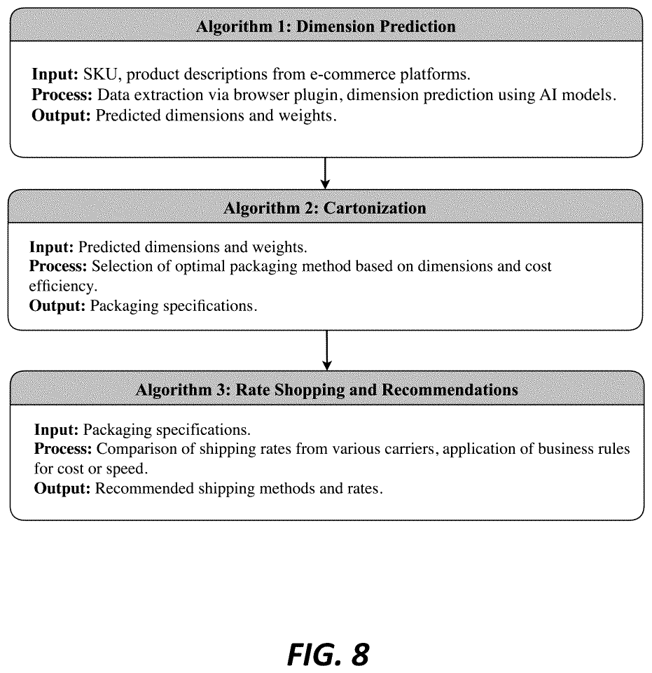

As illustrated in FIG. 7, the method uses a structured three-step process that improves e-Commerce logistics using advanced AI technologies. Initially, Algorithm 1: Dimension Prediction uses a custom browser plugin to extract SKU details, product descriptions, and quantities from e-Commerce platforms (FIG. 8). This algorithm utilizes Gen-AI and OpenAI technologies to predict precise product dimensions and weights accurately. Following this, Algorithm 2: Cartonization uses the predicted data to identify the most effective packaging methods that align with cost-efficiency and packaging standards (FIG. 8). This phase customizes packaging to meet product requirements and environmental standards, promoting cost-effective shipping solutions. Finally, Algorithm 3: Rate Shopping and Recommendations take these packaging specifications to compare various carrier rates, applying rules to prioritize cost efficiency or speed based on user preferences (FIG. 8). This phase determines the optimal shipping methods and rates, ensuring the most economical or quickest delivery options are available for users.

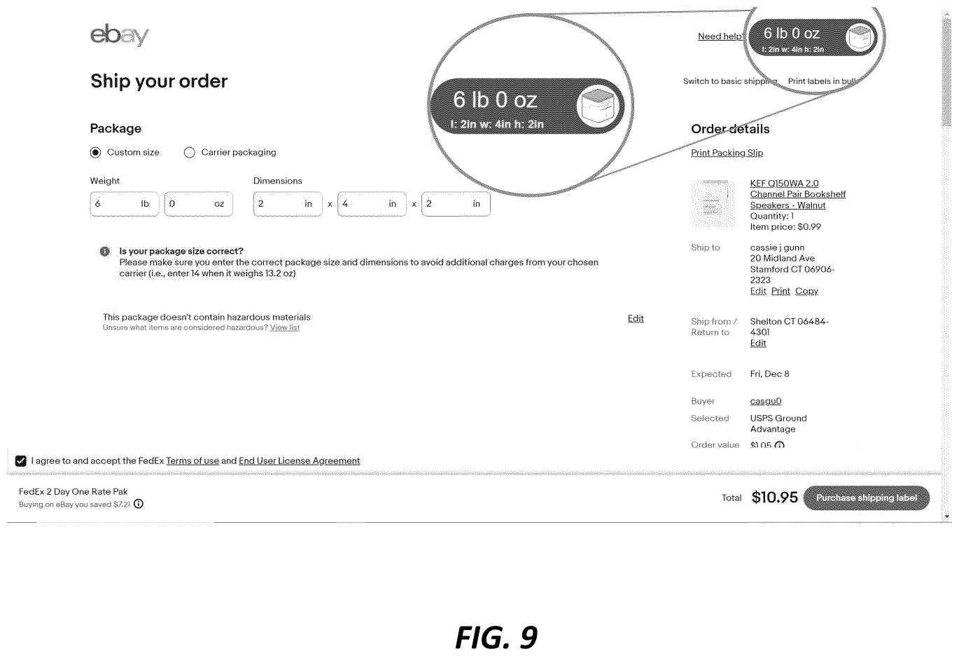

The first phase of the proposed approach (Algorithm 1) represents a comprehensive AI-driven solution to predict and optimize the dimensions of e-Commerce packages (FIG. 9). Starting with a set of important logistics data (D), the method goes through a series of steps to normalize and clean each data point.

Algorithm 1 Advanced dimension prediction
and optimization for E-Commerce logistics

Require:

```
  D ← Dataset with SKU, weights, dimensions, quality from e-Commerce platforms
  API ←Access to OpenAI API for generating embeddings
  M ←Set of pre-trained ML and Gen-AI models for dimension prediction
```

Ensure:

| | |
|---|---|
| | Optimized browser plugin with predictive capabilities and enhanced e-Commerce |
| | functionality. |
| 1: | Data Preprocessing: |
| 2: | Dₚᵣₑₚ = {normalize(clean(d)) \| d ∈ D} |
| 3: | D_{seg} = {segment(dₚᵣₑₚ) \| dₚᵣₑₚ ∈ Dprep} |
| 4: | AI-Driven Dimension Prediction: |
| 5: | for d ∈ D_{seg} do |
| 6: | e_{d} = API.embed(d) |
| 7: | d_{pred} = M.predict(e_{d}) |
| 8: | Store d_{pred} for later use |
| 9: | end for |
| 10: | Browser Plugin Development and Integration: |
| 11: | Develop and integrate plugin to automatically apply d_{pred} in real-time on platforms. |
| 12: | Real-World Application and Feedback Loop: |
| 13: | Deploy plugin on platforms (e.g., eBay, Amazon). |
| 14: | for each user interaction do |
| 15: | Collect feedback and adjust M accordingly. |
| 16: | end for |
| 17: | Evaluation and Optimization: |
| 18: | metrics = evaluate(D_{pred}, User Feedback) |
| 19: | M_{new} = optimize(M, metrics) |
| 20: | return Enhanced browser plugin |

These steps are shown by the normalize(.) and clean(.) functions. After being preprocessed, each item is split up and sent to a DL model through the OpenAI API. The model then creates embeddings that show what makes each item unique. These embeddings are utilized by predictive models M to estimate package dimensions accurately. The predictive outcomes d_{pred} are integrated into a custom browser plugin that interfaces seamlessly with e-Commerce platforms, applying predicted dimensions in real-time. User feedback continuously refines the plugin performance, shaping subsequent model training cycles and optimization phases. Metrics such as prediction accuracy and user satisfaction guide the iterative improvement process, ensuring that the plugin meets and exceeds e-Commerce logistics requirements.

Algorithm 2 Enhanced algorithm for package optimization

Require:

```
  HTML ← HTML content from e-Commerce product pages 1
  API Key ← Access key for OpenAI API
```

Ensure:

| | |
|---|---|
| | Optimized dimensions and weights for e-Commerce packaging. |
| 1: | Plugin Initialization: |
| 2: | Install plugin into Chrome Browser |
| 3: | Monitor for navigation to e-Commerce sites |
| 4: | Environment Detection: |
| 5: | if User navigates to a supported site then |
| 6: | Details ← parse(HTML) |
| 7: | E ← OpenAI.generate_embeddings(Details, APIKey) |
| 8: | end if |
| 9: | Embedding Generation and Analysis: |
| 10: | E ← OpenAI.generate_embeddings(Details) |
| 11: | Store E for analysis |
| 12: | Dimension and Weight Prediction: |
| 13: | Y_{pred} ← f_{predict}(E) |
| 14: | Optimize packaging based on Y_{pred} |
| 15: | Cartonization Process: |
| 16: | C ←f cartonize (Y_{pred}) |
| 17: | Update Fields: |
| 18: | Populate optimized dimensions and weights |
| 19: | Recommend shipping methods based on C |
| 20: | Feedback and Optimization: |
| 21: | Collect and analyze feedback to adjust f_{predict} and f_{cartonize} |
| 22: | return Enhanced shipping efficiency and reduced costs |

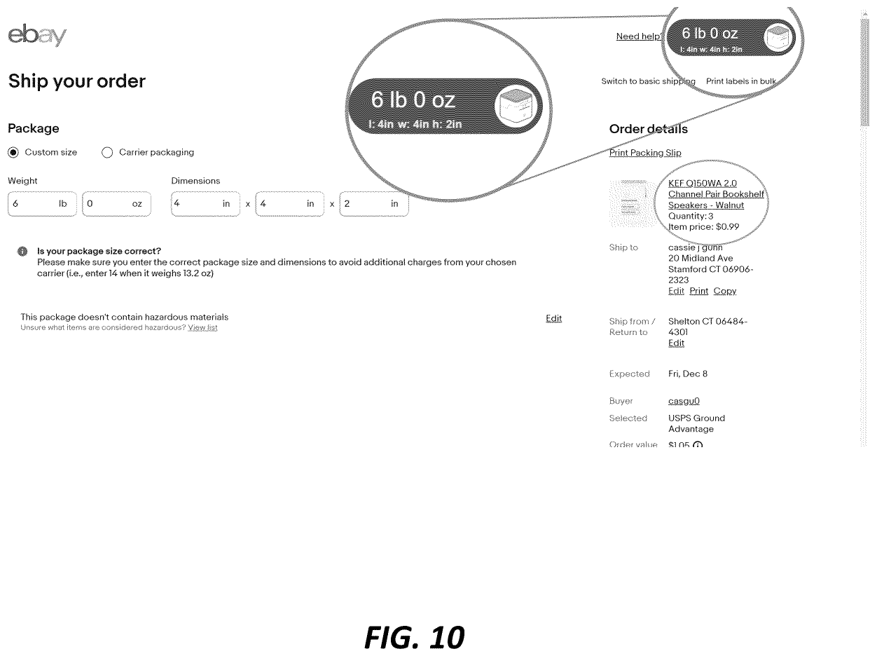

This phase (Algorithm 2) starts with deploying a browser plugin, which actively monitors navigation activities on e-Commerce platforms (Monitor for navigation) (FIG. 10). Upon detecting a supported site, the plugin retrieves and parses the HTML content, extracting critical product details represented by the variable Details. After that, these details are sent to the OpenAI API to create embeddings E, which is shown mathematically as E←OpenAI.generate embeddings(Details, APIKey). E is a high-dimensional representation of product characteristics that are needed for accurate dimension prediction. The algorithm uses these embeddings and a predictive function f_{predict}, written as Y_{pred}←f_{predict}(E), to figure out the best sizes and weights for packaging. This predictive phase uses pre-trained AI models to synthesize and analyze complex product data. The output Y_{pred}, which has the predicted sizes and weights, guides the next step, which is cartonization, using a strategy f_{cartonize}, written as C←f_{cartonize} (Y_{pred}). This function determines the most efficient pack aging method, optimizing both space and cost. The optimized dimensions and recommendations for shipping methods are then automatically populated into the e-Commerce platform's fields, facilitating an optimized user experience and enhanced operational efficiency. Continuous user feedback is collected and analyzed to refine the predictive and cartonization functions. This ensures that the system adapts to evolving user needs and market conditions, maintaining its effectiveness and efficiency in real-world applications.

Algorithm 3 Enhanced shipping rate and recommendation algorithm

| Require: | |
|---|---|
| | PD ← Package Details from Algorithm 2 (dimensions and weights) |
| | UP ← User Preferences (cost vs speed) |
| | CD ← Carrier Data (rates, discounts, thresholds) |
| Ensure: | |
| | Optimized shipping rate recommendations based on user preferences. |
| 1: | Extract Package Parameters: |
| 2: | P ← PD |
| 3: | User Priority Decision: |
| 4: | priority ← UP |
| 5: | Fetch Carrier Rates: |
| 6: | R ← API.get_rates(CD) |
| 7: | Apply Business Rules: |
| 8: | if P.size < threshold ∧ priority = cost then |
| 9: | R_{filtered} ← filter_rates_by_cost(R,CD) |
| 10: | else |
| 11: | R_{filtered} ← filter_rates_by_speed(R) |
| 12: | end if |
| 13: | Generate Recommendations: |
| 14: | if priority = cost then |
| 15: | Rec ← select_top(R_{filtered}, 2, min) |
| 16: | else if priority = speed then |
| 17: | Rec ← select_top(R_{filtered}, 2, max) |
| 18: | end if |
| 19: | Output Recommendations: |
| 20: | Display Rec along with estimated delivery times and costs. |
| 21: | User Review and Confirmation: |
| 22: | Provide Rec for user review and confirmation. |
| 23: | return Rec |

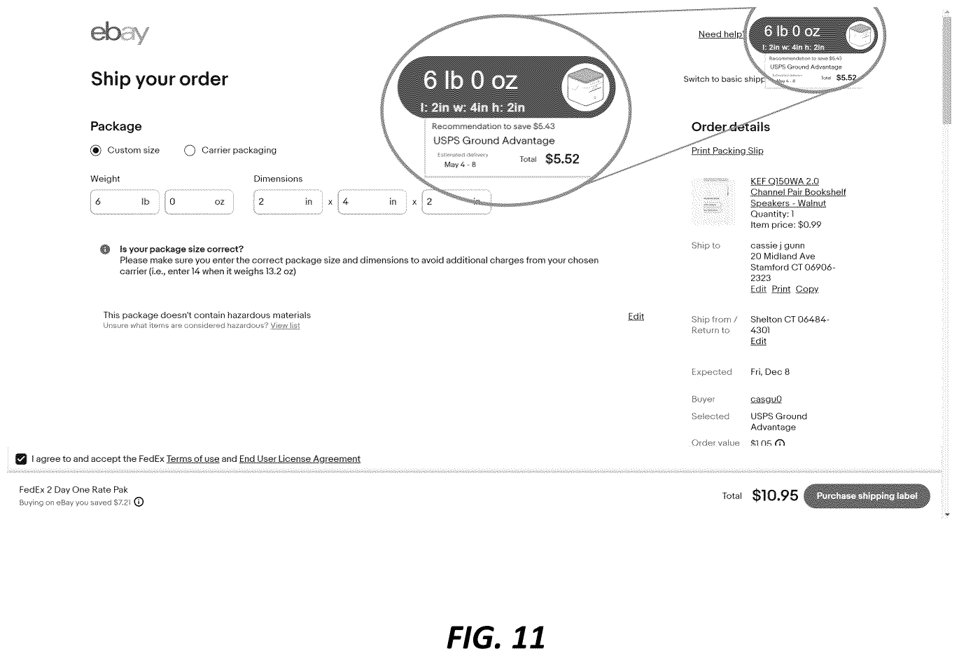

In this step (Algorithm 3), the details of the packages (PD) from the previous cartonization process are used to figure out the best ways to ship them, ref FIG. 11. User preferences (UP), which indicate the priority between cost and speed, guide the selection process for shipping options. The method fetches current carrier rates stored in CD, represented mathematically as R. Conditional filtering, which uses cost or speed parameters as criteria, picks a subset of these rates (R_{filtered}) based on the user's set of priorities. The decision-making process employs mathematical functions where filter_rates_by_cost( ) and filter_rates_by_speed( ) apply specific business rules related to cost and speed preferences, respectively. This targeted filtering ensures that the final selection phase considers only the most relevant shipping options. Using these filtered rates, the method then chooses the two best shipping options based on the priority given. Select_top(R, n, criterion) chooses the best n options based on the criterion, which can be either minimum cost or maximum speed. The result, Rec, is then displayed to the user, providing a clear, optimized choice between cost efficiency and delivery speed, ensuring alignment with user preferences and package specifications.

As described, foundational phase 1 process automates the extraction of product details, such as title, description, and SKU, from the HTML content of e-Commerce sites. Using OpenAI's API, this step creates embeddings from the extracted text. These are then used to guess the exact sizes and weights of the products. These predictions are directly integrated into the e-Commerce platform's product listings, ensuring that shipping information is precise and efficient. This process will now be described in greater detail as a series of steps.

It is contemplated that the plug-in software program could be provided as a series of layers, where each layer performs several functions. These layers could comprise: a Data Gathering layer, a Pre-Processing and Cleaning layer and an Outlier Detection layer.

A) Data Gathering layer. A dedicated web-browser plugin includes a Data Gathering (DG) module as an integral component of the system which is designed to be installed as a browser extension to e-Commerce sites (e.g., Amazon, eBay, Etsy Listings API). The DG module retrieves SKU identifiers, titles, descriptions, pricing, and seller-supplied dimensional data. To accommodate the structural heterogeneity of these marketplaces, each of which exposes product attributes through distinct DOM hierarchies, the DG module employs a pluggable adapter architecture. Marketplace-specific adapters hold declarative mapping templates and schema validators that normalize disparate data fields into Raw text prior to hand-off to the next software module. This design isolates scraper maintenance to individual adapters enabling rapid onboarding of new marketplaces without altering downstream logic.

eBay:
18 /Shipping/eBay/eBay-USA Bottle Caps.html
˜/Shipping/eBay/eBay-USA Bottle Caps.pdf

Etsy:
˜/Shipping/Etsy/Etsy-Personalized Resin Fridge Magnet.html
˜/Shipping/Etsy/Etsy-Personalized Resin Fridge Magnet.jpeg

B) Pre-Processing and Cleansing layer. Once the DG module has gathered product data as described above, this data is then processed by a Pre-Processing and Cleaning (PPC) module. The PPC module is adapted to perform the following functions:
1) Text Normalization. This would include using a character encoding standard, such as, Unicode Transformation Format-8 bits (UTF-8) canonicalization used to represent Unicode characters. This will function to standardize text to ensure that characters with multiple possible representations are converted into a single, unambiguous form. Text normalization may further include lower-casing, HTML stripping, and emoji removal.
2) Feature Extraction. This would include processing the normalized text using Regular Expression (Regex), which comprises a sequence of characters that specifies a match pattern in text+use of Natural Language Processing (NLP) to parse the length, width, height, weight, material composition, and category of the text into standardized units.
3) Imputation. This would include automatically generating missing numeric attributes via Multivariate Imputation by Chained Equations (MICE). MICE is a type of multiple imputation technique, meaning it generates several plausible sets of imputed values to replace the missing ones, rather than simply filling them with a single value. It does this by iteratively inputting missing values on a variable-by-variable basis using a series of regression models. This process step is described in greater detail below.
a) Initialization. This is where missing values are initially filled with temporary placeholder values (e.g., mean or median).
b) Iteration. This includes: 1) where for each variable with missing data, its placeholder values are set back to missing, 2) a regression model predicts this variable using observed and currently imputed values of other variables in the dataset, and 3) missing values for the chosen variable are then imputed based on the predictions from this model.
c) Chained Equations. The process cycles through each variable with missing data, updating the imputations based on the most recent values of other variables.
d) Convergence. The iterations continue until the imputations stabilize and converge to a point where additional iterations won't significantly change the imputed values.
e) Multiple Imputations. The iterative process is repeated multiple times (e.g., 5-20), generating multiple datasets with different imputed values.

C) Outlier Detection layer. There are numerous complexities in outlier detection for e-Commerce product data, which include: Data heterogeneity, Inconsistent units and formats, Missing or incorrect values, and Anomalies and noise each of which are broadly discussed below.

Data Heterogeneity. This problem is found in the fact that text is mixed from platform to platform. E-Commerce listings vary wildly with titles and description varying widely across sellers, categories and platforms. A product may be called one thing on a first website, a second thing on a second website and so on across multiple platforms. This requires an automated system to be able to translate all the different descriptions of a single type of product to create data homogeneity. As an example, this could include the following, “Length=80 in”, “80-inch long”, “Dimensions: 203 cm (L)”, which all refer to the same field but in different formats. Likewise, text and numeric data are often intermixed. The present system utilizes Regex and NLP parsing and Gen-AI LLM models to address these challenges. Without step-wise normalization, downstream cartonization and rate-shopping models would mis-size packages or mis-price labels.

Inconsistent Units and Formats. Another problem is that units and formats vary widely from website to website. For example, length, height, depth, and weight may appear in imperial (in/lbs) or metric (cm/kg) units. Carrier APIs expect metric or imperial consistency. Mixed units trigger DIM-weight errors. Likewise, price information may vary where the currency used could include (INR [symbol] , USD $, EUR €). This complicates price normalization.

Missing or Incorrect Values. Mistakes can occur when data relating to a product is input on a website. For example, product dimensions are often missing, estimated, or inaccurate. Additionally, shipping weight may or may not include packaging or be incorrectly entered by the seller. Cleansing prevents rare but catastrophic dimension typos (e.g., “400 cm magnet”) from skewing optimization.

Anomalies and Noise. This occurs when sellers inflate product attributes for SEO, such as, referring to a 12-inch item as “extra-large”. Still further, description fields may include a marketing copy or HTML, which functions to make parsing more difficult. Schema Unification is therefore important. A canonical table helped to plug multiple marketplaces into the same AI pipeline (dimension prediction, Isolation Forest checks, Mixed Integer Linear Programming (MILP) cartonizer) with zero code changes downstream.

To address these challenges, the process includes using various types of filters including 1) univariate filters, and 2) multivariate filters.

1) Univariate filters. These function by evaluating and ranking each feature (or variable) independently based on a criterion without considering the relationships between the features themselves. Univariate filters identify and select the most relevant features for a given task based solely on their individual performance with respect to the target variable. In one configuration, this would include using a Z-score and an Interquartile Range (IQR) rule as follows:

$$Z - score ( \vert z \vert > 3.5 ) and IQR rule ( Q 1 - 1.5 \cdot IQR , Q 3 + 1.5 \cdot IQR )$$

A Z-score is a statistical measure used to describe a data point's relationship to the mean (average) of a single variable's distribution identifying the standard deviations away from the mean a specific data point is. IQR rules involve a method for identifying and potentially removing outliers in a dataset based on a univariate. IQR rules define a range within which data points are within the typical distribution.

2) Multivariate filters. These are used to identify and remove unwanted covariance structures or patterns among multiple variables (features) in a dataset. Multivariate filters look at relationships and dependencies among multiple variables simultaneously to remove patterns that interfere with the desired analysis or modeling. These could include, for example, Isolation Forest with contamination ≤1%; Mahalanobis distance threshold χ² (4,0.997) for joint length-width-height-weight vectors.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

Outlier Detection Algorithms discussed above.

| Method | Purpose | Use Case |
|---|---|---|
| Z-Score Method | Detects values far from | Suitable for symmetric |
| | the mean | distributions |
| IQR Method | Captures outliers in skewed | Length, Width, Depth, |
| | data using percentiles | Weight |
| Isolation | Identifies multivariate | Dimensions + Weight + |
| Forest | anomalies | Volume |
| LOF/DBSCAN | Density-based detection for | SKU frequency in a |
| | clusters | category |
| Mahalanobis | Detects correlation-aware | High-dimensional feature |
| Distance | outliers in multi-dim space | vectors |

Challenges in Sourcing & Cleaning Data from Amazon, eBay, Etsy.

| Challenge | Description | Mitigation Strategy |
|---|---|---|
| Data Access | Platforms often restrict | Used web-browser to read |
| Restrictions | APIs or limit scraping to | from DOM using web- |
| | prevent data abuse | browser plugin/extension |
| Dynamic | HTML structures change | Used headless browsers + |
| Content | frequently, breaking | intelligent parsers (Gen-AI) |
| & Layouts | scrapers | |
| Rate Limits | Scraping gets throttled | Process only one at a time |
| & Captchas | or blocked | with user consent (ethically) |
| Unstructured | Descriptions are user- | Applied NLP models + |
| Descriptions | generated with no | heuristics + regex parsing + |
| | fixed schema | Gen-AI LLM Models |
| Cross- | Same product can have | Used deduplication models |
| Platform | different dimensions/ | (e.g., cosine/text sim.) |
| Variation | titles across platforms | |
| Language | Data can appear in | Used language detection + |
| Localization | multiple languages | Gen-AI LLM Models |

Example Data and Outcome of a Cleaned Entry: From HTML listing→structured, ready-for-model table for Etsy product listing (˜/Shipping/Etsy/Etsy-Personalized Resin Fridge Magnet.html)

| | | | Cleaning/ |
|---|---|---|---|
| | | | Normalization |
| Stage | Key Actions | Why It's Complex | Tactics |
| 1. HTML | Read DOM - raw HTML | Marketplace pages are | Strip <script>, |
| Acquisition & | from the website. | cluttered with ads, | <style>, hidden |
| Parsing | Parse with an HTML parser | scripts, | elements. |
| | (e.g., Beautiful Soup) to build | customer-review | Resolve |
| | a DOM tree. | widgets, and | lazy-loaded tags and |
| | | lazy-loaded sections | decode HTML |
| | | that obscure true | entities. |
| | | product data. | |
| 2. | Locate SKU, title, price, | Each marketplace | Adapter layer |
| Target-Element | description, and breadcrumbs | (Etsy, Amazon, eBay) | stores multiple |
| Identification | using XPath/CSS selectors and | uses a different | selector variants per |
| | fall-back heuristics (e.g., | markup schema; even | site. |
| | Open Graph meta tags, | within one site, the | If primary selectors |
| | JSON-LD “Product” blocks). | selectors change with | fail, fallback to |
| | | A/B tests. | JSON-LD or meta |
| | | | tags. |
| 3. Text | Extract text nodes, collapse | Seller-generated copy | Unicode |
| Extraction & | whitespace, remove | is full of emojis, | normalization |
| Pre-Cleaning | non-printable characters, | decorative symbols, & | (NFKC). Emoji & |
| | convert smart quotes. | repetitive adjectives | markup purge, but |
| | | (“Awesome gift!!!”). | keep domain-specific |
| | | | keywords (e.g., |
| | | | “resin”). |
| 4. Attribute | Apply regex/NLP patterns to | Units can be mixed | Compile unit |
| Parsing & Unit | detect numbers + units | (“vs in vs cm; lbs. vs g). | dictionaries; |
| Harmonization | (“4.5″ × 1.5″ × 0.5 cm”, | Sellers often put units | standardize to |
| | “36.2 lbs.”). | in different orders or | centimeters and |
| | | shorthand. | kilograms. |
| | | | Convert imperial |
| | | | → metric via fixed |
| | | | factors. |
| 5. Missing-Value | Flag absent weight; queue for | Weights are frequently | Set weight_g = |
| & Outlier | later AI imputation. | omitted for | NULL. No extreme |
| Handling | Validate extracted | lightweight items. | outliers detected → |
| | dimensions with z-score/IQR | Sellers sometimes | keep values; |
| | checks against reference | exaggerate size for | otherwise mark |
| | distribution for magnets. | visibility. | clean_flags. |
| 6. Canonical | Map raw fields into a | Cross-platform | Adapter layer maps |
| Schema | standard table: sku, title, | interoperability | site-specific keys → |
| Mapping | description, length_cm, etc. | requires one schema, | Canonical JSON |
| | Derive materials from | but each site names | schema. |
| | keyword matches. | fields differently | |
| | | (item_id, listingId, | |
| | | ASIN). | |
| 7. Category & | Use breadcrumb | Breadcrumb text may | Fuzzy-match |
| Taxonomy | “Party Favors & | contain marketing fluff | breadcrumb strings |
| Resolution | Games > Party Favors” to | or missing levels. | against an internal |
| | assign a three-level taxonomy. | | category ontology; if |
| | | | ambiguous, default |
| | | | to nearest parent. |
| 8. Table | Assemble cleaned values into | Must remain | Consistent column |
| Generation & | a DataFrame/CSV/JSON | human-readable yet | order; null |
| Output | row. | machine-ready. | placeholders (“Not |
| | Surface in chat as a readable | | specified”); numeric |
| | table. | | fields cast to float for |
| | | | downstream ML. |

Pseudo-code. Below is a concise, language-agnostic pseudocode blueprint for the full extraction-and-cleansing algorithm.

PSEUDOCODE: Cross-Marketplace Listing Normalizer

```
# 0. CONFIGURATION
CANONICAL_SCHEMA = [
  “sku”, “title”, “description”, “length_cm”,
  “width_cm”, “height_cm”, “weight_kg”,
  “price”, “currency”, “category_path”,
  “materials”, “clean_flags”
]
```

| | |
|---|---|
| UNIT_MAP = { | # conversion to metric |

```
  “in”: 2.54, “inch”: 2.54, “cm”: 1, “mm”: 0.1,
  “ft”: 30.48, “lb”: 0.453592, “lbs”: 0.453592, “g”: 0.001, “kg”: 1
}
Z_THRESHOLD = 3.5
IQR_FACTOR = 1.5
```

| | |
|---|---|
| ISO_CONTAM = 0.01 | # isolation-forest expected outlier ratio |

# 1. ENTRYPOINT --------------------------------------------------
function NORMALISE_LISTING(input_url):

| | | |
|---|---|---|
| html | ← PLUGIN FETCH_DOM(input_url) | # browser plug-in call |
| site_id | ← DETECT_MARKETPLACE(html) | # “amazon” / “ebay” / “etsy” |
| adapter | ← LOAD_ADAPTER(site_id) | # DOM selectors & patterns |
| raw_dict | ← EXTRACT FIELDS(html, adapter) | # Step 2 |
| clean_row | ← CLEAN AND_VALIDATE(raw_dict) | # Steps 3-7 |
| return | clean_row | |

```
# 2. FIELD EXTRACTION --------------------------------------------
function EXTRACT_FIELDS(html, adapter):
  data = { }
  for each field in adapter.SELECTORS:
    node_text ← html.find(adapter.SELECTORS[field]).text
    data[field] = STRIP_HTML(node_text)
  # Fall-back to JSON-LD / OpenGraph if missing
  if missing(data[“sku”]):
    data.update( PARSE_JSON_LD(html) )
  return data
# 3. TEXT NORMALISATION -----------------------------------------
function NORMALISE_TEXT(txt):
```

| | |
|---|---|
| txt ← unicode_norm(txt) | # NFC / NFKC |

```
  txt ← remove_emojis(txt)
  txt ← collapse_whitespace(txt)
  return txt.strip( )
# 4. UNIT PARSING & CONVERSION ----------------------------------
function PARSE_DIMENSIONS(desc):
  # regex pattern = r“([\d\.]+)\s*(in|inch|cm|mm|ft)”
```

| | |
|---|---|
| triples = REGEX_FIND_ALL(desc, DIM_PATTERN) | # returns list of (num, unit) |

```
  dims_cm = [ ]
  for (num, unit) in triples:
    dims_cm.append( float(num) * UNIT_MAP[unit] )
```

| | |
|---|---|
| return dims_cm[0:3] | # length, width, height (if available) |

function PARSE_WEIGHT(desc):

| | |
|---|---|
| match = REGEX_FIND(desc, WEIGHT_PATTERN) | # e.g., “36.2 lbs” |

```
  if match:
    return float(match.num) * UNIT_MAP[match.unit]
  else:
    return NULL
# 5. MISSING-VALUE HANDLING -------------------------------------
function IMPUTE_IF_MISSING(row, field, category_stats):
  if missing(row[field]):
    row[field] = category_stats.median(field)
    row[“clean_flags”] += “|imputed_” + field
  return row
# 6. OUTLIER DETECTION ------------------------------------------
function UNIVARIATE_OUTLIER(value, μ, σ, Q1, Q3):
  z_ok = abs(value − μ) / σ ≤ Z_THRESHOLD
  iqr_ok = (value ≥ Q1 − IQR_FACTOR*(Q3−Q1)) and (value ≤ Q3 +
IQR_FACTOR*(Q3−Q1))
  return (z_ok and iqr_ok)
function MULTIVARIATE_OUTLIER(vector, iso_model):
```

| | |
|---|---|
| return iso_model.predict(vector) == −1 | # −1 ⇒ outlier |

```
# 7. CANONICAL MAPPING & FINAL CLEAN ----------------------------
function CLEAN_AND_VALIDATE(raw):
  row = DICT_INIT(CANONICAL_SCHEMA)
  # 7.1 Normalise text fields
```

| | |
|---|---|
| row[“title”] | = NORMALISE_TEXT(raw[“title”]) |

```
  row[“description”] = NORMALISE_TEXT(raw[“description”])
  # 7.2 Numeric extraction
```

| | |
|---|---|
| (L,W,H) | = PARSE_DIMENSIONS(raw[“description”] + raw[“title”]) |
| row[“length_cm”] | = L |
| row[“width_cm”] | = W |
| row[“height_cm”] | = H |
| row[“weight_kg”] | = PARSE_WEIGHT(raw[“description”]) |

```
  # 7.3 Unit tests & imputation
  stats = CATEGORY_STATS_LOOKUP(raw[“category_path”])
  for field in [“length_cm”,“width_cm”,“height_cm”,“weight_kg”]:
    row = IMPUTE_IF_MISSING(row, field, stats)
  # 7.4 Outlier checks
  if not UNIVARIATE_OUTLIER(row[“length_cm”], stats.μ_L, stats.σ_L, stats.Q1_L,
stats.Q3_L):
    row[“clean_flags”] += “|outlier_length”
  vector = [row[“length_cm”], row[“width_cm”], row[“height_cm”], row[“weight_kg”]]
  if MULTIVARIATE_OUTLIER(vector, iso_model=stats.iso_model):
    row[“clean_flags”] += “|iso_outlier”
  # 7.5 Final casting
```

| | |
|---|---|
| row[“sku”] | = raw[“sku”] |
| row[“price”] | = float(raw.get(“price”, 0)) |

```
  row[“currency”] = raw.get(“currency”,”USD”)
  row[“materials”] = EXTRACT_MATERIALS(raw[“description”])
  return row
```

Code Explanation.
Plug-in layer: PLUGIN_FETCH_DOM (current-domain-page) as a headless-browser script that injects marketplace-specific adapters.
Adapter registry: LOAD_ADAPTER(site_id) returns a YAML/JSON file with CSS/XPath selectors and regex patterns unique to each marketplace.
Statistics store: CATEGORY_STATS_LOOKUP( ) retrieves per-category means, standard deviations, quartiles, and a pre-trained Isolation-Forest model periodically recomputed on the warehouse's historical data.
Scalability: Wrap NORMALISE_LISTING( ) in an async worker or Spark UDF for bulk crawling and real-time webhook ingestion.

Output (Input for Algorithm-1):

| Attributes | Value |
|---|---|
| SKU | 1872288989 |
| Title | Personalized Resin Fridge Magnet \| Custom |
| | Locker Decor \| Unique Gift for Kids \| |
| | Valentine's Favor \| Party Return Gift |
| Description | Personalized handmade resin magnet for fridges, |
| | lockers or any magnetic surface. Each piece is |
| | hand-poured and fully customizable in colors, |
| | shapes and text. Ideal as a thoughtful gift |
| | for birthdays, holidays or party return favors. |
| | Materials: high-quality resin with durable |
| | magnetic backing; glossy, smooth finish. Dimensions: |
| | 4.5″ × 1.5″ × 0.5 cm. |
| Length (cm) | 4.5 |
| Width (cm) | 1.5 |
| Height (cm) | 0.5 |
| Weight (g) | Not specified |
| Price (USD) | 10.00 |
| Category | Paper & Party Supplies > Party Supplies > Party |
| Path | Favours & Games > Party Favours |
| Materials | Resin body, magnetic backing |

Other Sample data from 2.5M training data:

| SKU | Title | Description | Description | Product_Type_ID | Product_Length |
|---|---|---|---|---|---|
| 2075497 | Antique Home | [Size | Antique | 5565 | 866.1417314 |
| | Decor Wooden | Approx (in | traditional | | |
| | Hand Painted and | CM): | handmade | | |
| | Handmade | Height 55 | peacock wall | | |
| | Hanging Wind | cm, Width | decor Handmade | | |
| | Chimes Pieces | 22 Cm, | Rajasthani bell | | |
| | (Multicolor) | peacock | wall hanging | | |
| | Handcrafted | wall | with bells for | | |
| | Decorative | hanging | Bell shaped | | |
| | Wall/Door/Window | home decor, | Wind chime for | | |
| | Hanging Bells | a beautiful | your house or | | |
| | (Bell) Peacock | Combination | office decor and | | |
| | | of | positive | | |
| | | handmade | atmosphere. | | |
| | | & hand | Wind chimes | | |
| | | painted | sound creates | | |
| | | bells | peace and is a | | |
| | | Decorative | Feng Sui. Its a | | |
| | | elephants | peacock wall | | |
| | | along with | decoration items | | |
| | | beautiful | makes home | | |
| | | Wind | beautiful and | | |
| | | chime bells, | sounds like a | | |
| | | Material: | wind chime that | | |
| | | Metal bells, | contains | | |
| | | wood & | handmade & | | |
| | | plastic, | hand painted | | |
| | | Makes a | elephants | | |
| | | peace full | hanging in | | |
| | | sound | strings with | | |
| | | which feels | golden bells that | | |
| | | pleasant | makes beautiful | | |
| | | and positive | and smooth | | |
| | | to the ears | sound. The | | |
| | | and helps to | product will be | | |
| | | relax, Idol | exactly the same | | |
| | | for home | as show in the | | |
| | | decoration, | picture. | | |
| | | wall decor, | | | |
| | | can be | | | |
| | | hanged | | | |
| | | anywhere | | | |
| | | like | | | |
| | | window, | | | |
| | | balcony, | | | |
| | | terrace, | | | |
| | | roof top | | | |
| | | gardens, | | | |
| | | living room, | | | |
| | | main gate | | | |
| | | entrance | | | |
| | | etc. The | | | |
| | | product is | | | |
| | | made by | | | |
| | | skilled | | | |
| | | artists. Its a | | | |
| | | great | | | |
| | | Rajasthani | | | |
| | | handmade | | | |
| | | handicraft | | | |
| | | home | | | |
| | | decor. its | | | |
| | | perfect for | | | |
| | | gifting and | | | |
| | | decoration | | | |
| | | both. Its | | | |
| | | one of the | | | |
| | | finest | | | |
| | | rajasthani | | | |
| | | hanging | | | |
| | | decoration | | | |
| | | items. | | | |
| | | peacock | | | |
| | | wall | | | |
| | | decoration | | | |
| | | items] | | | |
| 1188856 | Zinus 18 Inch | [Your | The Next | 1626 | 8000.0 |
| | Premium | purchase | Generation Bed | | |
| | SmartBase | includes | Frame - The | | |
| | Mattress | One Zinus | Premium 18 Inch | | |
| | Foundation/4 | Casey | SmartBase | | |
| | Extra Inches high | Premium | Mattress | | |
| | for Under-bed | SmartBase | Foundation by | | |
| | Storage/Platform | 18-Inch | Zinus eliminates | | |
| | Bed Frame/Box | Mattress | the need for a | | |
| | Spring | Foundation | box spring as | | |
| | Replacement/ | in Queen | your memory | | |
| | Strong/Sturdy/ | Size. | foam, spring or | | |
| | Quiet Noise-Free, | Mattress is | latex mattress | | |
| | Queen | not | should be placed | | |
| | | included, Bed | directly on the | | |
| | | frame | Premium | | |
| | | dimensions: | SmartBase. | | |
| | | 60″ W × | Uniquely | | |
| | | 80″ L × 18″ | designed for | | |
| | | H. Bed | optimum support | | |
| | | frame | and durability | | |
| | | weight: | the strong steel | | |
| | | 36.2 lbs. \| | mattress support | | |
| | | Clearance | has multiple | | |
| | | space: 17″ \| | points of contact | | |
| | | Core | with the floor for | | |
| | | Composition - | stability and | | |
| | | Steel | prevents | | |
| | | Frames and | mattress sagging, | | |
| | | wires, | increasing | | |
| | | Compatible | mattress life. | | |
| | | frames: | The Premium | | |
| | | memory | SmartBase bed | | |
| | | foam, | frame is 18 | | |
| | | spring | inches high with | | |
| | | and/or | 16.5 inches of | | |
| | | pillow top | clearance under | | |
| | | mattresses, | the frame for 4 | | |
| | | Requires | extra inches of | | |
| | | the use of | under-bed | | |
| | | SmartBase | storage space. | | |
| | | headboard | With plastic caps | | |
| | | brackets | to protect your | | |
| | | (not | floors and an | | |
| | | included) to | innovative | | |
| | | connect to a | folding design to | | |
| | | headboard, | allow for easy | | |
| | | Smartbases | storage, the | | |
| | | do not | SmartBase is | | |
| | | require a | well designed for | | |
| | | box spring, | ease of use. | | |
| | | in fact the | Worry free 5- | | |
| | | added | year limited | | |
| | | height is | warranty. Another | | |
| | | meant to | comfort | | |
| | | replace the | innovation from | | |
| | | box spring | Zinus. | | |
| | | and provide | Pioneering | | |
| | | you with | comfort. | | |
| | | ample | | | |
| | | storage | | | |
| | | space using | | | |
| | | our “Smart” | | | |
| | | patented | | | |
| | | design] | | | |

The accuracy of AI-driven dimension prediction is a key factor in optimizing logistics processes. The model's predictive performance was assessed against actual measured values, and the results across different product categories are presented in Table 1.

TABLE 1
Dimension and Weight Prediction Accuracy

| | Mean Absolute | Mean Absolute | Prediction |
|---|---|---|---|
| Product Category | Error (mm) | Error (g) | Accuracy (%) |
| Electronics | 3.6 | 22.4 | 96.1 |
| Books | 3.2 | 18.9 | 96.8 |
| Clothing | 6.1 | 31.2 | 90.2 |
| Home Goods | 7.8 | 45.3 | 88.7 |
| Toys | 8.5 | 48.1 | 87.4 |

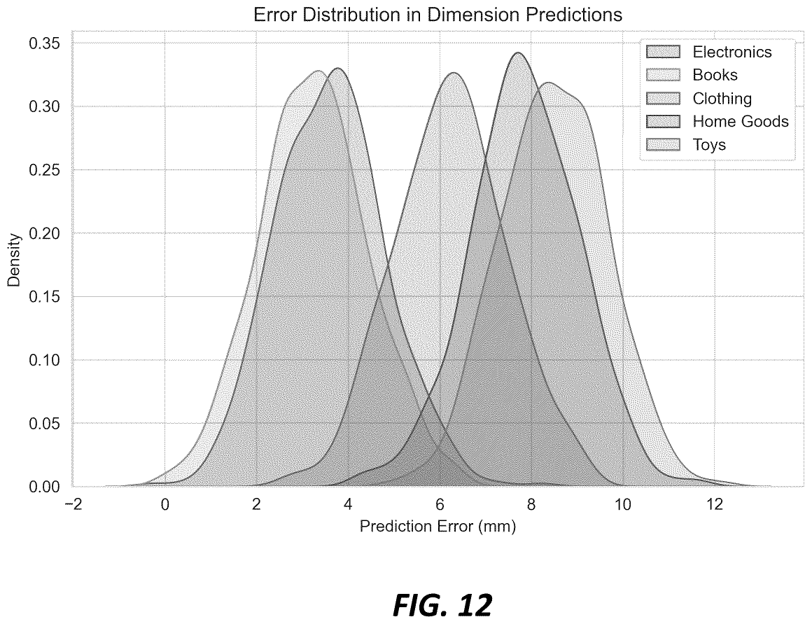

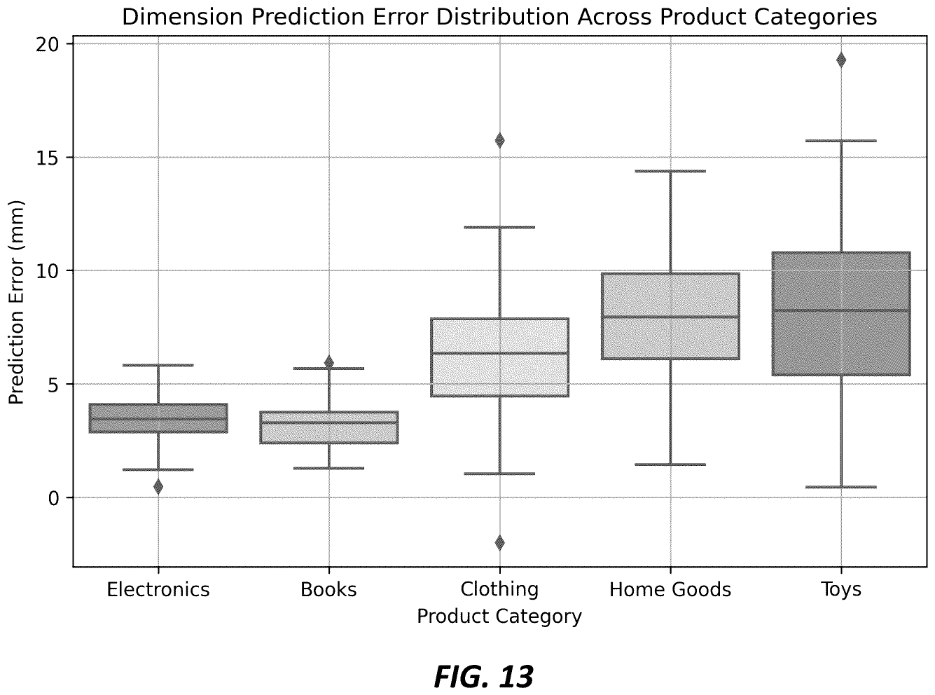

The error distribution in dimension predictions is visualized in FIG. 12. The analysis reveals that while structured products such as books and electronics achieve higher accuracy, categories with irregular shapes, such as home goods and toys, exhibit higher variance in predictions. Further insights into the variation of errors across different product categories are provided in FIG. 13, which presents the density distribution of dimension prediction errors.

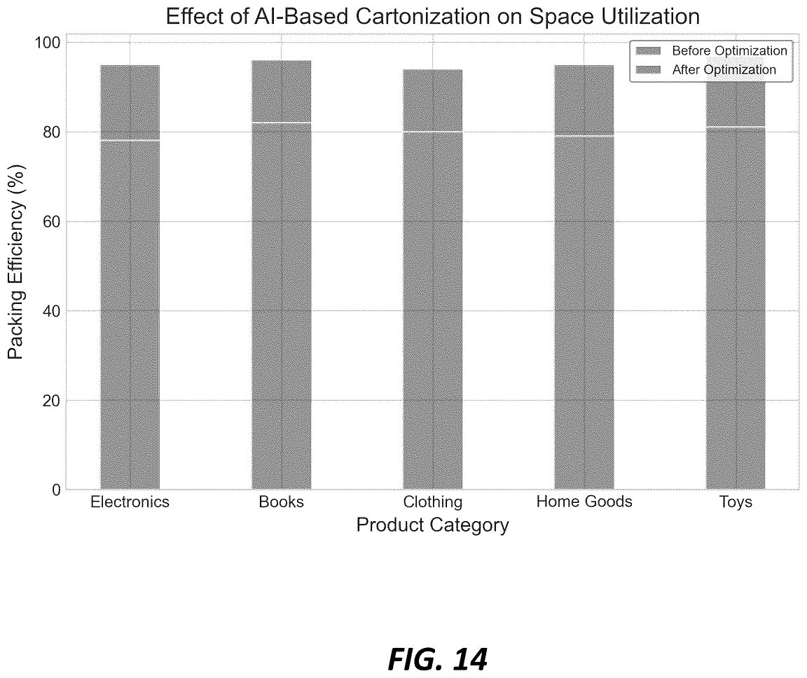

The AI-based cartonization optimization strategy significantly enhances space utilization and reduces unnecessary packaging volume. Table 2 presents a comparative analysis of key performance metrics before and after optimization. The overall impact of cartonization optimization is illustrated in FIG. 14, where the AI-driven approach achieves a 95% packing efficiency, leading to substantial space savings.

TABLE 2
Impact of AI-Based Cartonization Optimization

| | Before | After | Improvement |
|---|---|---|---|
| Metric | Optimization | Optimization | (%) |
| Packing Efficiency | 85.0 | 95.0 | +10.0 |
| (%) | | | |
| Dimensional Weight | — | 23.7 | — |
| Reduction (%) | | | |
| Space Utilization (%) | 72.1 | 94.2 | +30.7 |
| Processing Time (s) | 12.5 | 8.3 | −33.5 |

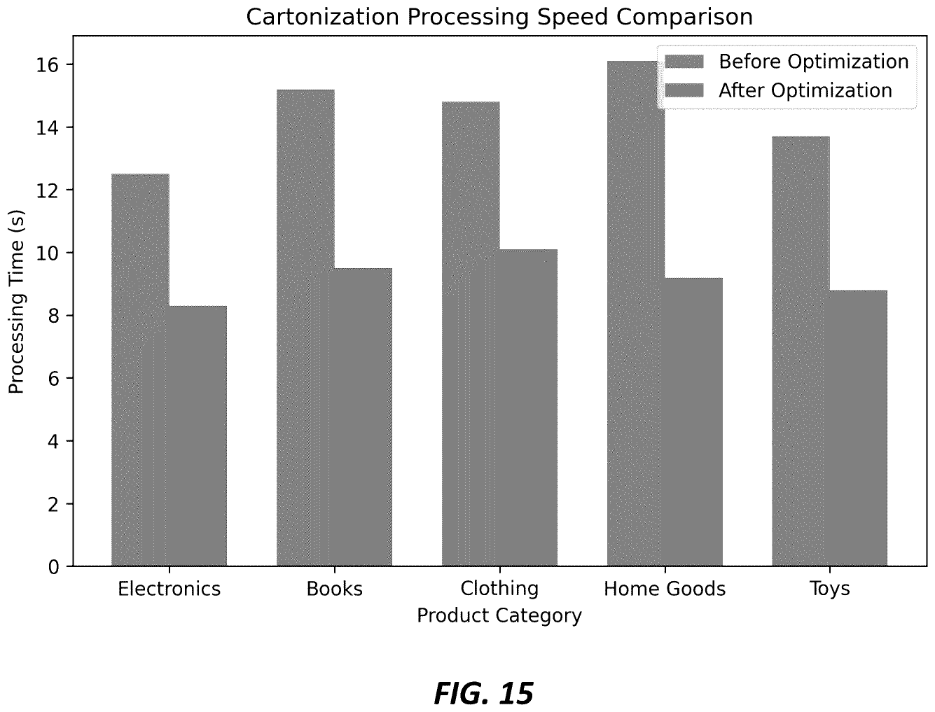

Additionally, the effect of AI on improving cartonization processing speed is depicted in FIG. 15. The reduction in processing time is evident across all product categories, supporting the efficiency gains of the proposed method.

The AI-powered rate shopping algorithm optimally selects shipping carriers based on a balance of cost and speed, leading to substantial savings. Table 3 compares the performance of traditional and AI-optimized rate shopping.

TABLE 3
Cost Comparison: Traditional vs. AI-Optimized Rate Shopping

| | Traditional | AI | Improvement |
|---|---|---|---|
| Shipping Metric | Method | Optimized | (%) |
| Average Shipping | 10.80 | 8.50 | −21.3 |
| Cost ($) | | | |
| Carrier Selection | 78.5 | 96.2 | +17.7 |
| Accuracy (%) | | | |
| Expedited Shipping | 54.3 | 68.9 | +26.9 |
| Selection (%) | | | |

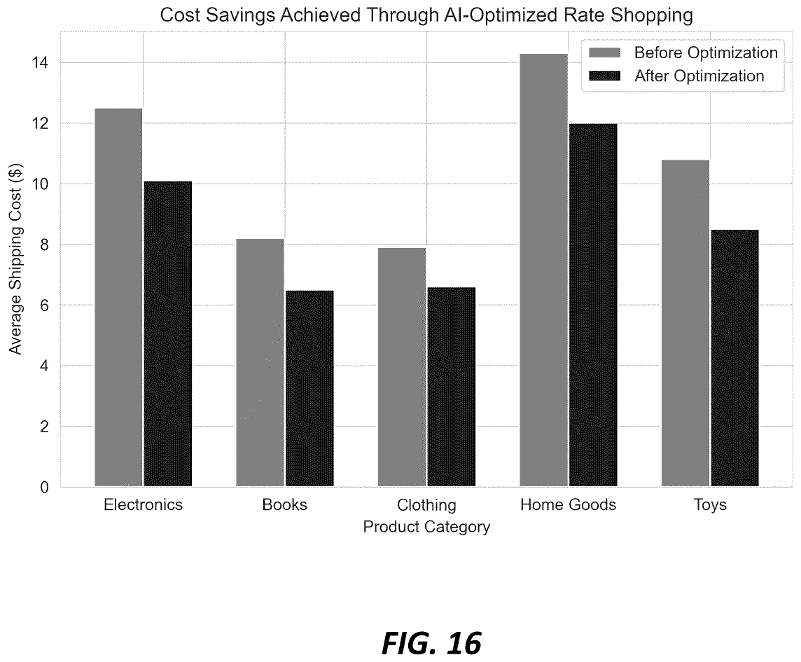

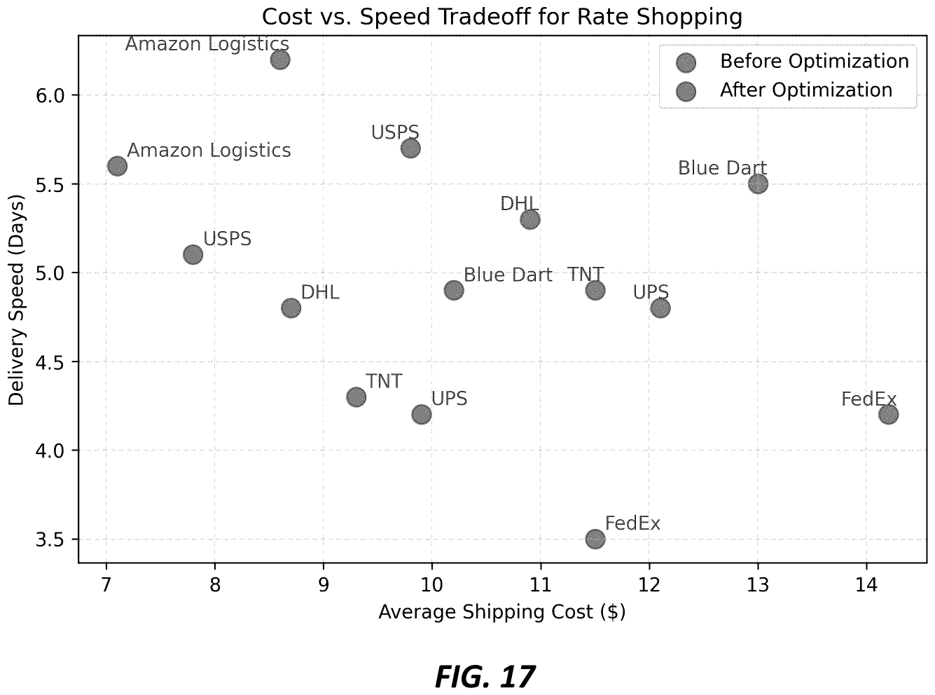

FIG. 16 visualizes the cost savings achieved through AI-optimized rate shopping. Moreover, the tradeoff between cost and speed across different carriers is depicted in FIG. 17, highlighting the efficiency of AI in selecting optimal shipping strategies.

As outlined in Table 4, the AI-based framework achieves a 35.2% reduction in processing time compared to traditional methods. This efficiency is further supported by the enhanced cartonization process, which optimizes packaging configurations to minimize dimensional weight charges and material usage. By leveraging machine learning, the system improves packing efficiency by 10%, ensuring better space utilization and cost-effective shipping.

TABLE 4
Performance Comparison: Traditional vs. AI-Based Logistics

| Metric | Traditional | AI-Based | Improvement (%) |
|---|---|---|---|
| Manual Processing | 45.2 | 29.3 | −35.2 |
| Time (s) | | | |
| Packing Efficiency | 85.0 | 95.0 | +10.0 |
| (%) | | | |
| Carrier Selection | 78.5 | 96.2 | +17.7 |
| Accuracy (%) | | | |
| Shipping Cost | — | −21.3 | — |
| Savings (%) | | | |

Carrier selection is another critical factor influencing logistics costs and delivery performance. The AI-driven rate shopping mechanism dynamically evaluates real-time carrier rates, selecting the most cost-effective and reliable option based on shipping constraints and customer preferences. The optimization process improves carrier selection accuracy by 17.7%, ensuring that shipments are aligned with the most efficient service providers. Moreover, the intelligent selection strategy reduces overall shipping costs by 21.3%, as demonstrated in Table 4. These improvements indicate that AI-based rate shopping significantly enhances cost savings while maintaining fast and reliable delivery performance.

The adaptability of this framework extends beyond cost and efficiency gains. Its modular design enables businesses to integrate AI-driven optimization into their logistics operations without requiring extensive modifications to existing infrastructure. Additionally, the system continuously learns from historical shipping data, allowing it to refine predictions and decision-making over time. This ensures long-term improvements in efficiency, making the system a sustainable solution for e-Commerce logistics management.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A system for automated dimensioning and optimized packaging of one or more purchased products via a computer having a storage accessing one or more e-Commerce websites via a network connection, the system comprising:
a software module adapted to access a database of information relating to products offered for sale on the one or more e-Commerce websites and executing on the computer including:
a Data Gathering layer adapted to extract structural attributes of a product to generate raw product data,
a Pre-Processing and Cleaning layer adapted to normalize the raw product data, extract feature data, and generate missing dimensional data via a Generative Artificial Intelligence (Gen-AI) model to generate processed data,
an Outlier Detection layer adapted to utilize one or more filters to analyze the processed data to identify and remove anomalous data and generate corrected data, which is saved to the computer storage,
the Gen-AI model is adapted to access the database of information and gather package dimensions for the one or more purchased products;
the Gen-AI model is adapted to generate a packing configuration for packaging of the one or more purchased products.

2. The system of claim 1, wherein the normalization of the raw product data includes using an encoding standard to:
remove Hypertext Markup Language (HTML), special characters, and emojis, and
convert capital letters to lower case letters.

3. The system of claim 2, wherein the extraction of feature data includes:
using stock keeping unit (SKU) descriptions to extract data including height, width, depth, and weight of the at least one product; and
using Regular Expression (Regex) and Natural Language Processing (NLP) patterns and Gen-AI Large Language Models (LLM) models to convert text to standardized units.

4. The system of claim 3, wherein the generating of missing dimensional data includes:
imputation by generating missing attributes using a multiple imputation technique by iteratively inputting values;
wherein the missing attributes are selected from the group consisting of text, numeric values and combinations thereof.

5. The system of claim 4, wherein when the missing attributes comprise text, the input values comprise text fields where missing descriptions are replaced with category-level summaries.

6. The system of claim 4, wherein when the missing attributes comprise numeric values, the input values comprise numeric fields where median imputation or Multivariate Imputation by Chained Equations (MICE) is used to generate the missing numeric value.

7. The system of claim 3, wherein the Pre-Processing and Cleaning layer is further adapted to generate missing weight data via the Gen-AI model to generate the processed data, and the Gen-AI model is adapted to gather package weight for purchased products.

8. The system of claim 1, wherein the one or more filters are selected from the group consisting of: univariate filters, multivariate filters, and combinations thereof.

9. The system of claim 8, wherein when a univariate filter is selected, the univariate filter uses a process selected from the group consisting of: a Z-score, an Interquartile Range (IQR) rule, and combinations thereof to rank each feature or variable.

10. The system of claim 8, wherein when a multivariate filter is selected, the multivariate filter uses a process selected from the group consisting of: an Isolation Forest, a Mahalanobis distance threshold, and combinations thereof to remove covariance structures or patterns among multiple features or variables.

11. The system of claim 1, wherein an algorithm is adapted to query multiple carriers to recommend a cost-optimized or time-optimized shipping label based on real-time carrier rates and user preferences.

12. A method for automated dimensioning and optimized packaging of one or more purchased products via a computer accessing one or more e-Commerce websites via a network connection, the computer including a storage and having a software module executing thereon and accessing a database of information relating to products offered for sale on the one or more e-Commerce websites, the method comprising the steps of:
extracting structural attributes of a product to generate raw product data with a Data Gathering layer executing within the software module,
normalizing the raw product data, extracting feature data, and generating missing dimensional data via a Generative Artificial Intelligence (Gen-AI) model with a Pre-Processing and Cleaning layer executing within the software module,
analyzing the processed data with one or more filters to identify and remove anomalous data and generate corrected data with an Outlier Detection layer executing within the software module,
saving the corrected data on the computer storage,
accessing the database of information and gather package dimensions for the one or more purchased products with the Gen-AI model, and
generating a packing configuration for packaging of the one or more purchased products with the Gen-AI model.

13. The method of claim 12, wherein the step of normalization of the raw product data further includes the steps of:
removing Hypertext Markup Language (HTML), special characters, and emojis, and
converting capital letters to lower case letters.

14. The method of claim 13, wherein the step of extraction of feature data further includes the steps of:
extracting data using stock keeping unit (SKU) descriptions which include height, width, depth, and weight of the at least one product; and
converting text to standardized units using Regular Expression (Regex) and Natural Language Processing (NLP) patterns and Gen-AI Large Language Models (LLM) models.

15. The method of claim 14, further comprising the steps of:
generating missing weight data via the Gen-AI model to generate the processed data with the Pre-Processing and Cleaning layer, and
gathering package weight for the purchased products.

16. The method of claim 14, wherein the step of generating of missing dimensional data further includes the steps of:
generating missing attributes by imputation using a multiple imputation technique by iteratively inputting values;
wherein the missing attributes are selected from the group consisting of text, numeric values and combinations thereof.

17. The method of claim 16, wherein
when the missing attributes comprise text, the input values comprise text fields where missing descriptions are replaced with category-level summaries, and
when the missing attributes comprise numeric values, the input values comprise numeric fields where median imputation or Multivariate Imputation by Chained Equations (MICE) is used to generate the missing numeric value.

18. The method of claim 12, wherein the one or more filters are selected from the group consisting of: univariate filters, multivariate filters, and combinations thereof.

19. The method of claim 17, wherein
when a univariate filter is selected, the univariate filter uses a process selected from the group consisting of: a Z-score, an Interquartile Range (IQR) rule, and combinations thereof to rank each feature or variable; and
when a multivariate filter is selected, the multivariate filter uses a process selected from the group consisting of: an Isolation Forest, a Mahalanobis distance threshold, and combinations thereof to remove covariance structures or patterns among multiple features or variables.

20. The method of claim 12, further comprising the step of:
querying multiple carriers with an algorithm to recommend a cost-optimized or time-optimized shipping label based on real-time carrier rates and user preferences.
